(19) United States
(12) Patent Application Publication
(10) Pub. No.: US 2009/0319164 A1
(43) Pub. Date: Dec. 24, 2009

(54) SYSTEM AND METHOD FOR REDUCING ENERGY CONSUMPTION OVER A BROAD GEOGRAPHIC AREA USING AIRCRAFT CONTRAILS

(75) Inventor: Nathan J. Harrington, Cary, NC (US)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/131,063

(22) Filed: May 31, 2008

(51) Int. Cl. G06F 17/00

(52) U.S. Cl. 701/120

(57) ABSTRACT

A method for controlling aircraft contrail placement including detecting an aircraft contrail, determining an approximate location of the aircraft contrail based on at least one of detected aircraft contrail pan information, tilt information, or zoom information, transmitting contrail detection information and contrail location information to a centralized controlling unit, matching the contrail location information with a database of known GPS coordinates to identify the contrail producing aircraft, determining a boundary for an energy management area, determining an amount of cloud cover over the energy management area, determining an optimal cloud cover amount for the energy management area, and transmitting a re-route request to the identified contrail producing aircraft to re-route toward or away from the energy management area based on the determining an amount of optimal cloud cover amount for the energy management area.

### TECHNICAL FIELD

The present disclosure generally relates to the field of energy consumption and more particularly to an energy management system for geographical areas, such as large metropolitan areas.

### BACKGROUND

Current electrical power generation systems can become nearly overwhelmed during times of peak power consumption. For example, extremely hot and sunny days can cause electrical demand that exceeds the maximum electrical output of a power generation station. In addition, the subsequent increase in particulates and gas emissions from a fossil fuel burning electrical generation facility can exacerbate chemical air quality and other environmental effects associated with extremely hot days.

### SUMMARY

An embodiment of the present disclosure is directed to a method for controlling aircraft contrail placement including, but not limited to, detecting an aircraft contrail, further including: utilizing at least one of a land based sensor or a space based sensor to detect the aircraft contrail; determining an approximate location of the aircraft contrail based on at least one of detected aircraft contrail pan information, tilt information, or zoom information, transmitting contrail detection information and contrail location information to a centralized controlling unit, matching the contrail location information with a database of known GPS coordinates to identify the contrail producing aircraft, determining a boundary for an energy management area, determining an amount of cloud cover over the energy management area, determining an optimal cloud cover amount for the energy management area, and transmitting a re-route request to the identified contrail producing aircraft to re-route toward or away from the energy management area based on the determining an amount of optimal cloud cover amount for the energy management area.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for reducing energy consumption over a broad geographic area.

### DETAILED DESCRIPTION

Reference will now be made in detail to the subject matter disclosed, which is illustrated in the accompanying drawings.

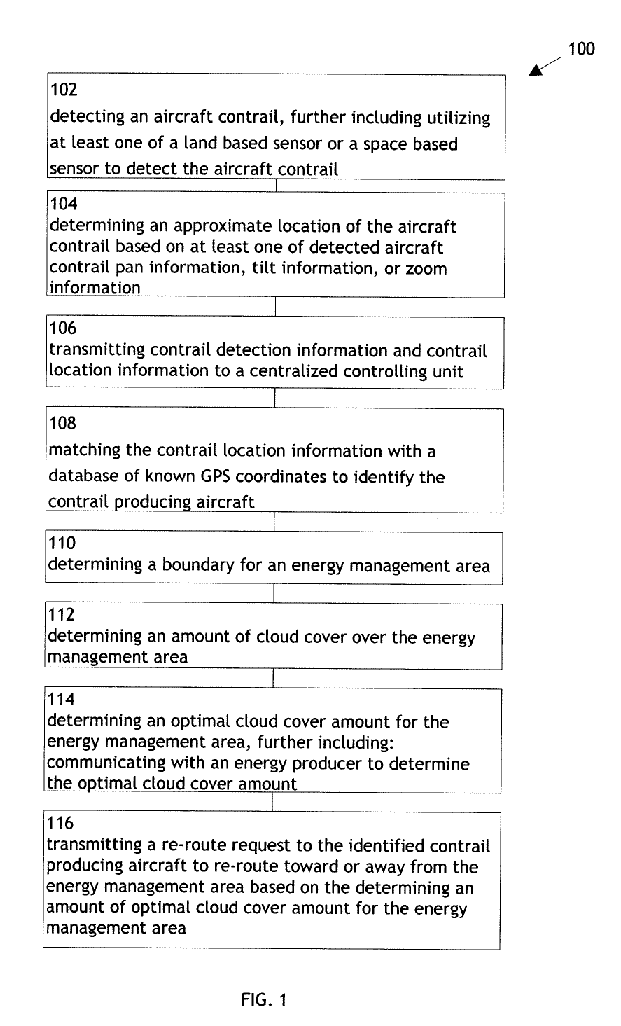

Referring to FIG. 1, the method 100 includes detecting an aircraft contrail, further including utilizing at least one of a land based sensor or a space based sensor to detect the aircraft contrail 102. To this end, method 100 may create a contrail detection network including a plurality of contrail detection devices configured to detect an aircraft contrail.

Method 100 also includes determining an approximate location of the aircraft contrail based on at least one of detected aircraft contrail pan information, tilt information, or zoom information 104. To this end, method 100 may include providing a location determination network including a plurality of location determination devices (e.g., GPS devices). The contrail detection network may utilize optical detection (e.g., optical image processing) to detect the presence of a contrail in the upper atmosphere. The contrail detection network may also utilizing orbital spacecraft contrail detection (e.g., a NOAA weather satellite). Method 100 may transmit contrail detection information and contrail location information to a centralized controlling unit 106. Method 100 may then match the contrail location information with a database of known GPS coordinates to identify the contrail producing aircraft 108. Method 100 may utilize a central controlling unit to provide the matching of the approximate location and the database of known GPS coordinates of current flights. Method 100 may further utilize the central controlling unit to transmit a sales request and provide pricing information to a flight provider.

Method 100 may determine a boundary for an energy management area 110. Energy management area may be a set of coordinates bounding a geographical area where contrail activity is monitored. Method 100 may associate a contrail detection system with an energy management area 112.

At least one contrail detection system may be associated with an energy management area. As contrails are formed over the energy management area, the approximate coordinates are sent to the central controlling system. Method 100 may determine an amount of cloud cover over the energy management area 112, and determine an optimal cloud cover amount for the energy management area 114. Determining an optimal cloud cover amount for the energy management area may also include communicating with an energy producer to determine the optimal cloud cover amount.

Method 100 may include transmitting a re-route request to the identified contrail producing aircraft to re-route toward or away from the energy management area based on the determining an amount of optimal cloud cover amount for the energy management area 116. For instance, if contrails are desired over the energy management area (such as on a very hot day), method 100 may transmit the GPS coordinates, along with pricing data, to an aircraft within a certain proximity to the energy management area. If the nearby aircraft operators accept the pricing model, the aircraft may divert an originally determined flight course to match the altitude and position required for contrail creation at a position within the energy management area. The associated reduction in solar radiation reaching the earth's surface will result in less electrical consumption for cooling purposes. Conversely, if contrails are not desired over the energy management area (such as on a very cold day), aircraft will be given coordinates and pricing data with which to avoid the energy management area. The associated increase in solar radiation reaching the earth's surface may result in less electrical consumption for heating purposes.

Consider the following illustrative usage examples: Energy company “SouthEast-Energy” has a network of coal fired electrical generation stations throughout the southeast. Current electrical generation capacity is nearly exceeded due to extremely high temperatures and subsequent high air conditioning demand. SouthEast-Energy installs a contrail detector covering a large urban area, such as Raleigh, where demand for electrical powered cooling devices like air conditioners is high. When a contrail is detected over the area, the approximate coordinates of the aircraft generating the contrail are determined by its position in the sky. These coordinates are sent to the central controlling system.

The central controlling system queries recent GPS records for all aircraft in the area to find the coordinates of the aircraft producing the contrail. The central controlling system then queries its energy management area and finds that high incident cloud cover is desired in the Raleigh area where the contrail is located. Aircraft with flight paths that will take it near the Raleigh energy management area are queried from the GPS database of current flights in the southeast.

The central controlling station then determines a price point for aircraft operator (e.g., American Airlines) compensation to divert the aircraft along a flight path that will produce contrails over the Raleigh energy management area. The airline accepts the proposed pricing from the central controlling station and communicates flight path diversion information to the aircraft approaching the Raleigh energy management area. Additional contrails are formed over the Raleigh urban area, and the occlusion of direct sunlight reduces the total energy consumption from air conditioners and other devices.

SouthEast-Energy has sent X amount of dollars to the aircraft operator to increase the incident cloud cover, but saved Y amount of dollars due to the lower energy consumption rates. Additionally, SouthEast-Energy saves large amounts of money by maintaining current electrical production capacity instead of building additional facilities. The aircraft operator has slightly increased its fuel consumption and transit times due to the altering of course, but has gained X dollars additional revenue. Both companies benefit from the public relations advantage of the overall reduced power plant emissions such as particulates and greenhouse gases.

Six months later, SouthEast-Energy is again approaching maximum capacity of electrical generation due to extremely cold temperatures. High electrical demand is taxing the production capacity due to sub freezing temperatures activating thousands of electrical heating systems. A contrail is detected over the Raleigh area and the respective contrail coordinates are sent to the central controlling station. Clouds are not desired over the Raleigh area at this time, as direct sunlight will increase the ambient temperature in the energy management area. The central controlling system queries the GPS database to find current aircraft with flight paths that will take them over the Raleigh area. These aircraft are then sent the GPS coordinates of the area and altitude to avoid, along with what price SouthEast-Energy is willing to pay the aircraft operator for the required change in course. The airline accepts the proposed pricing and diverts the aircraft around the Raleigh energy management area. Due to the decrease in cloud cover, the amount of solar radiation reaching the ground will increase and the subsequent demand on the electrical energy production capacity of SouthEast-Energy's facilities may decrease because of the warmer ground temperatures.

SouthEast-Energy has sent X amount of dollars to the aircraft operator to prevent the formation of contrails, and saved Y amount of dollars due to lower energy consumption rates. Additionally, SouthEast-Energy saves large amounts of money by maintaining current electrical production capacity instead of building additional facilities. The aircraft operator has slightly increased its fuel consumption and total aircraft transit times, but has gained X dollars in additional revenue. Both companies benefit from the public relations advantage of the overall reduction in fossil fuel based electrical power generation emissions, such as greenhouse gases and particulates.

The method 100 provides active control of a small portion of an incident cloud cover over a geographical area. The method may utilize any combination of existing high altitude jet aircraft producing contrails, GPS indications of position, and a pricing module to control the portion of incident cloud cover over the geographical area. If clouds are desired over an area, the power generation facility will request that aircraft transiting the general area divert course to a specific position that produces contrails. Appropriate monetary compensation is offered to the aircraft operator to offset increased fuel usage and other expenses. The power generation facility sees an overall reduction in power consumption due to the reduction in solar radiation reaching the earth's surface because of increased cloud cover. The compensation provided the aircraft operator is recouped through reductions in overall electrical power generation. While retaining electrical generation capacity, both aircraft operator and power generation facility contribute to reduced chemical and particulate emissions.

A system of active aircraft contrail control increasing or preventing contrail cloud cover over a specific energy management area is also contemplated. System may include a network of contrail detection systems for detecting contrails over a specific geographic energy management area using land or space based sensors to detect contrails. System may also include at least one receiver/transmitter for receiving and transmitting contrail detection information to and from a centralized controlling unit. Centralized controlling unit may evaluate the need for cloud cover or clear air over an energy management area, communicate with energy producers to determine desired cloud cover, request contrail producing aircraft to divert over or away from the energy management area.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for controlling aircraft contrail placement including:
detecting an aircraft contrail, further including:
utilizing at least one of a land based sensor or a space based sensor to detect the aircraft contrail;
determining an approximate location of the aircraft contrail based on at least one of detected aircraft contrail pan information, tilt information, or zoom information;
transmitting contrail detection information and contrail location information to a centralized controlling unit;
matching the contrail location information with a database of known GPS coordinates to identify the contrail producing aircraft;
determining a boundary for an energy management area;
determining an amount of cloud cover over the energy management area;
determining an optimal cloud cover amount for the energy management area, further including:
communicating with an energy producer to determine the optimal cloud cover amount; and
transmitting a re-route request to the identified contrail producing aircraft to re-route toward or away from the energy management area based on the determining an amount of optimal cloud cover amount for the energy management area.
